(19) United States
(12) Patent Application Publication
(10) Pub. No.: US 2024/0175163 A1
(43) Pub. Date: May 30, 2024

(54) FILM FORMING APPARATUS FOR FORMING METAL FILM

(71) Applicant: TOYOTA JIDOSHA KABUSHIKI KAISHA, Toyota-shi (JP)

(72) Inventor: Kazuaki OKAMOTO, Toyota-shi (JP)

(73) Assignee: TOYOTA JIDOSHA KABUSHIKI KAISHA, Toyota-shi (JP)

(21) Appl. No.: 18/514,417

(22) Filed: Nov. 20, 2023

(30) Foreign Application Priority Data
Nov. 29, 2022 (JP) 2022-190548

(51) Int. Cl. C25D 5/00; C25D 7/06; C25D 21/12

(52) U.S. Cl. CPC C25D 5/67; C25D 7/065; C25D 21/12

(57) ABSTRACT

Provided is a film forming apparatus for forming a metal film capable of replacing an electrolyte membrane at a proper timing along with further degradation in the electrolyte membrane. The film forming apparatus includes a housing for containing a plating solution, the housing having an electrolyte membrane removably attached thereto; a replacement mechanism configured to replace the electrolyte membrane attached to the housing; a detecting device configured to detect a state of the electrolyte membrane or a state of the surface of the substrate after film formation; and a control device configured to control replacement of the electrolyte membrane. The control device determines whether there is degradation in the electrolyte membrane based on a result of detection by the detecting device, and if it is determined that the electrolyte membrane is degraded, causes the replacement mechanism to replace the electrolyte membrane.

### CROSS REFERENCE TO RELATED APPLICATIONS

The present application claims priority from Japanese patent application JP 2022-190548 filed on Nov. 29, 2022, the entire content of which is hereby incorporated by reference into this application.

### BACKGROUND

### Technical Field

The present disclosure relates to a film forming apparatus for forming a metal film.

### Background Art

Conventionally, a film forming apparatus for forming a metal film has been used, which deposits metal from metal ions in a plating solution on the surface of a substrate by electroplating (see, for example, JP 2022-046180 A). In this film forming apparatus, a metal film is formed on the surface of the substrate by electroplating in a state where the electrolyte membrane is pressed against the surface of the substrate with the fluid pressure of the plating solution. Here, since the fluid pressure of the plating solution acts on the electrolyte membrane, sagging of the electrolyte membrane or the like may occur. In view of this, the film forming apparatus may be provided with a mechanism that applies a constant tension to the electrolyte membrane.

Unfortunately, continuous use of the electrolyte membrane may cause degradation in the electrolyte membrane. When the electrolyte membrane is further degraded, a metal film having a uniform thickness may not be formed. In such a case, it is desired to replace the electrolyte membrane at a proper timing along with further degradation in the electrolyte membrane.

In view of the foregoing, the present disclosure provides a film forming apparatus for forming a metal film capable of replacing the electrolyte membrane at a proper timing along with further degradation in the electrolyte membrane.

### SUMMARY

In view of the above issue, a film forming apparatus according to the present disclosure is a film forming apparatus for forming a metal film on a surface of a substrate by electroplating in a state where an electrolyte membrane is pressed against the surface of the substrate with a fluid pressure of a plating solution. The film forming apparatus includes: a housing for containing a plating solution, the housing having the electrolyte membrane removably attached thereto; a replacement mechanism configured to replace the electrolyte membrane attached to the housing; a detecting device configured to detect a state of the electrolyte membrane or a state of the surface of the substrate after film formation; and a control device configured to control replacement of the electrolyte membrane. The control device determines whether there is degradation in the electrolyte membrane based on a result of detection by the detecting device, and if it is determined that the electrolyte membrane is degraded, causes the replacement mechanism to replace the electrolyte membrane.

In the present disclosure, a metal film is formed on the surface of the substrate in a state where the electrolyte membrane is pressed against the surface of the substrate with the fluid pressure of the plating solution. Repeated formation of the metal film causes the electrolyte membrane to not only contact the plating solution for a long period of time, but also be subjected to the fluid pressure of the plating solution. This causes further degradation in the electrolyte membrane. Thus, according to the present disclosure, in order to determine a state of the degradation in the electrolyte membrane, the detecting device detects a state of the electrolyte membrane attached to the housing or a state of the surface of the substrate after film formation. The control device determines whether there is degradation in the electrolyte membrane based on the result of detection by the detecting device. If the control device determines that the electrolyte membrane is degraded, under the control of the control device, the replacement mechanism replaces the degraded electrolyte membrane with a new electrolyte membrane. Consequently, it is possible to replace the electrolyte membrane at a proper timing along with further degradation in the electrolyte membrane.

In one aspect, the detecting device may be an imaging device configured to capture an image of the electrolyte membrane, and the control device may estimate an area rate of a wrinkle formed in the electrolyte membrane or an amount of sagging of the electrolyte membrane from an image of the electrolyte membrane captured by the imaging device, and may determine whether there is degradation in the electrolyte membrane based on the area rate of the wrinkle or the amount of sagging of the electrolyte membrane.

During film formation, the electrolyte membrane comes into contact with the substrate in a state where the electrolyte membrane is stretched with the fluid pressure of the plating solution. Repetition of such a phenomenon may cause a wrinkle in the electrolyte membrane or sagging of the electrolyte membrane. When the wrinkle in the electrolyte membrane increases or the sagging of the electrolyte membrane increases, the electrolyte membrane may easily be damaged and a metal film may not be formed. Such a state of the electrolyte membrane is a state where there is degradation in the electrolyte membrane. Thus, according to this aspect, using the detection result of the image of the electrolyte membrane captured by the imaging device, the control device estimates an area rate of a wrinkle formed in the electrolyte membrane or an amount of sagging of the electrolyte membrane from an image of the electrolyte membrane. Since this area rate of the wrinkle or amount of sagging of the electrolyte membrane depends on the degree of degradation in the electrolyte membrane, the control device can determine, based on the area rate of the wrinkle or the amount of sagging of the electrolyte membrane, whether there is degradation in the electrolyte membrane, which serves as a reference for replacing the electrolyte membrane.

In another aspect, the detecting device may be an imaging device configured to capture an image of the surface of the substrate after film formation, and the control device may estimate an amount of the plating solution adhering to the surface of the substrate from an image of the surface of the substrate captured by the imaging device and may determine whether there is degradation in the electrolyte membrane based on the amount of the plating solution adhering to the surface of the substrate.

During film formation, the electrolyte membrane comes into contact with the substrate in a state where the electrolyte membrane is stretched with the fluid pressure of the plating solution. Repetition of such a phenomenon may cause the plating solution to easily pass through the electrolyte membrane. As a result, the plating solution in an amount larger than expected may adhere to the surface of the substrate after film formation. Such a state of the electrolyte membrane is a state where there is degradation in the electrolyte membrane. Thus, according to this aspect, using the detection result of the image of the surface of the substrate captured by the imaging device, the control device can estimate an amount of the plating solution adhering to the surface of the substrate. Since this amount of the adhering plating solution depends on the degree of degradation in the electrolyte membrane, the control device can determine whether there is degradation in the electrolyte membrane based on this amount of the adhering plating solution.

In another aspect, the detecting device may be a weight measuring device configured to measure a weight of the electrolyte membrane, and the control device may determine whether there is degradation in the electrolyte membrane based on the weight measured by the weight measuring device.

During film formation, the electrolyte membrane comes into contact with the substrate in a state where the electrolyte membrane is stretched with the fluid pressure of the plating solution. Repetition of such a phenomenon causes the electrolyte membrane to be impregnated with the plating solution and swell, and increases the weight of the electrolyte membrane. As a result, the film strength of the electrolyte membrane may be decreased. Such a state of the electrolyte membrane is a state where there is degradation in the electrolyte membrane. Thus, according to this aspect, since the weight of the electrolyte membrane depends on the degree of degradation in the electrolyte membrane, the control device can determine whether there is degradation in the electrolyte membrane based on the weight of the electrolyte membrane.

In one aspect, the electrolyte membrane to be attached to the housing may be a portion of a band body made of electrolyte, and the replacement mechanism may include: a conveying device configured to convey the band body in a longitudinal direction; and an attaching and detaching mechanism configured to attach and detach the electrolyte membrane to and from the housing. When replacing the electrolyte membrane, the control device may cause the attaching and detaching mechanism to detach the electrolyte membrane from the housing, cause the conveying device to convey the band body to a position where an unused electrolyte membrane faces the housing, and cause the attaching and detaching mechanism to attach the unused electrolyte membrane to the housing.

According to this aspect, if the control device determines that the electrolyte membrane is degraded, under the control of the control device, the replacement mechanism can replace the electrolyte membrane. Specifically, under the control of the control device, the attaching and detaching mechanism detaches the electrolyte membrane from the housing and the conveying device conveys the band body to a position where an unused electrolyte membrane faces the housing. In this way, when replacing the electrolyte membrane, a plurality of times of replacement of the electrolyte membrane are available from one band body.

In another aspect, the electrolyte membrane may be removably attached to the housing via a frame, and the electrolyte membrane may be securely attached to the frame, the replacement mechanism may include: a conveying device configured to convey the frame; and an attaching and detaching mechanism configured to attach and detach the frame to and from the housing. When replacing the electrolyte membrane, the control device may cause the attaching and detaching mechanism to detach the frame from the housing, cause the conveying device to convey the detached frame to a position spaced from the housing and thereafter convey a frame having an unused electrolyte membrane securely attached thereto to a position facing the housing, and cause the attaching and detaching mechanism to attach the frame having an unused electrolyte membrane securely attached thereto to the housing.

According to this aspect, if the control device determines that the electrolyte membrane is degraded, under the control of the control device, the replacement mechanism can replace the electrolyte membrane. Specifically, under the control of the control device, the attaching and detaching mechanism can detach the degraded electrolyte membrane from the housing together with the frame and attach to the housing the unused electrolyte membrane securely attached to the different frame. In this way, the electrolyte membrane can be simply replaced together with the frame.

According to the present disclosure, it is possible to replace the electrolyte membrane at a proper timing along with further degradation in the electrolyte membrane.

### BRIEF DESCRIPTION OF THE DRAWINGS

FIG. 1 is a schematic cross-sectional view of an example of a film forming apparatus for forming a metal film according to an embodiment of the present disclosure;

FIG. 2 is a view illustrating a film forming method for forming a metal film using the film forming apparatus shown in FIG. 1;

FIG. 3 is a schematic perspective view of a replacement mechanism of the film forming apparatus shown in FIG. 1;

FIG. 4 is a view illustrating a method for replacing an electrolyte membrane using the film forming apparatus shown in FIG. 1;

FIG. 5 is a flowchart of the film forming method and replacement of an electrolyte membrane using the film forming apparatus shown in FIG. 1;

FIG. 6A is an image of an electrolyte membrane captured using an imaging device shown in FIG. 1, where the electrolyte membrane is not degraded;

FIG. 6B is an image of an electrolyte membrane captured using an imaging device shown in FIG. 1, where the electrolyte membrane is degraded;

FIG. 7 is a schematic cross-sectional view of an example of a film forming apparatus for forming a metal film according to a modification;

FIG. 8 is a flowchart of the film forming method and replacement of an electrolyte membrane using the film forming apparatus shown in FIG. 7;

FIG. 9 is a schematic cross-sectional view of an example of a film forming apparatus for forming a metal film according to another modification;

FIG. 10 is a flowchart of the film forming method and replacement of an electrolyte membrane using the film forming apparatus shown in FIG. 9; and

FIG. 11 is a schematic cross-sectional view of an example of a film forming apparatus for forming a metal film according to yet another modification.

### DETAILED DESCRIPTION

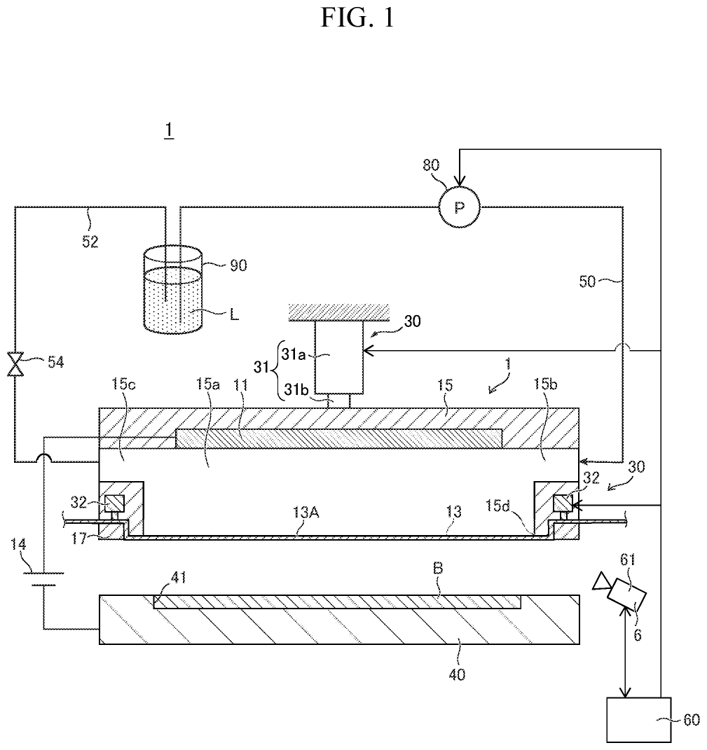

First, a film forming apparatus 1 for forming a metal film according to an embodiment of the present disclosure will be described. FIG. 1 is a schematic cross-sectional view of an example of the film forming apparatus for forming a metal film according to the embodiment of the present disclosure.

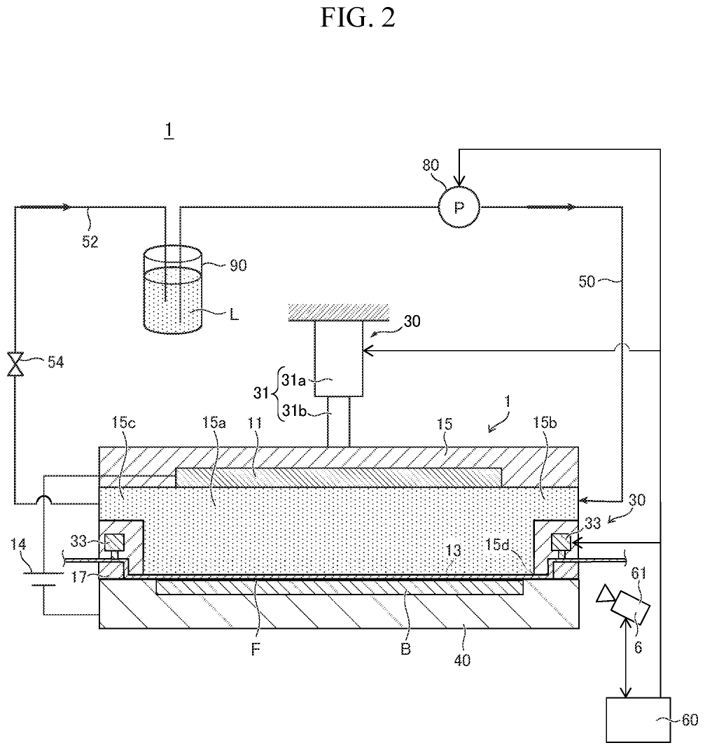

As shown in FIG. 1, the film forming apparatus 1 is a film forming apparatus for forming a metal film F on a substrate B by electroplating. Specifically, as shown in FIG. 2, the film forming apparatus 1 forms a metal film F in a state where an electrolyte membrane 13 is pressed against the surface of the substrate B with a fluid pressure of a plating solution. The film forming apparatus 1 includes an anode 11, an electrolyte membrane 13, and a power supply 14 that applies a voltage between the anode 11 and the substrate B.

The film forming apparatus 1 further includes a housing 15, a mount base 40, and a first linear actuator 31. In the present embodiment, for convenience of explanation, the electrolyte membrane 13 is disposed below the anode 11 and further the substrate B is disposed below the electrolyte membrane 13. However, the positional relation is not limited to this as long as the metal film F can be formed on the surface of the substrate B.

The substrate B functions as a cathode. The material of the substrate B is not particularly limited as long as the substrate B functions as a cathode (i.e., a conductive surface). The substrate B may be made of, for example, a metallic material, such as aluminum or copper. When forming a wiring pattern using the metal film F, for the substrate B, a substrate having an underlayer of copper or the like formed on the surface of an insulating substrate made of a resin or the like may be used. In this case, after the metal film F is formed, the underlayer other than the portion on which the metal film F is formed is removed by etching or the like. In this way, a wiring pattern using the metal film F can be formed on the surface of the insulating substrate.

In one example, the anode 11 is a non-porous anode made of the same metal as the metal of the metal film. The anode 11 has a block shape or a flat plate shape. The anode 11 may be made of copper, for example. The anode 11 dissolves when a voltage is applied by the power supply 14. However, when a film is formed using only metal ions in the plating solution L, the anode 11 is an anode insoluble in the plating solution L. The anode 11 is electrically connected to the positive electrode of the power supply 14. The negative electrode of the power supply 14 is electrically connected to the substrate B via the mount base 40.

The plating solution L is a liquid containing the metal of the metal film to be formed in the state of ions. Examples of the metal may include copper, nickel, gold, silver, iron, and the like. The plating solution L is a solution obtained by dissolving (ionizing) these metals with an acid such as nitric acid, phosphoric acid, succinic acid, sulfuric acid, or pyrophosphoric acid. Examples of the solvent of the solution include water and alcohol. For example, when the metal is copper, the plating solution L may be an aqueous solution containing copper sulfate, copper pyrophosphate, or the like.

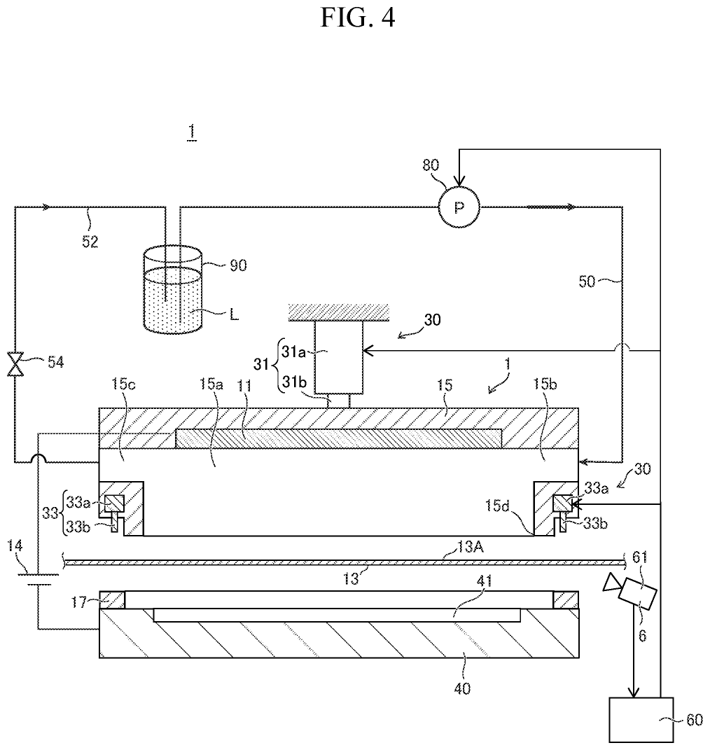

The electrolyte membrane 13 is a membrane that can be impregnated with metal ions (i.e., can contain metal ions therein) together with the plating solution L when brought into contact with the plating solution L. The electrolyte membrane 13 is a flexible membrane. The material of the electrolyte membrane 13 is not particularly limited as long as metal ions of the plating solution L can move toward the substrate B when the power supply 14 applies a voltage. Examples of the material of the electrolyte membrane 13 may include a resin having an ion exchange function such as a fluorine-based resin such as Nafion (registered trademark) available from DuPont. The thickness of the electrolyte membrane may be in the range of 20 μm to 200 μm. Specifically, the film thickness may be in the range of 20 μm to 60 μm. In the present embodiment, the electrolyte membrane 13 to be attached to the housing 15 is a portion of a band body 13A made of electrolyte (see FIG. 4).

The housing 15 is made of a material insoluble in the plating solution L. The housing 15 includes a storage space 15a for storing the plating solution. The anode 11 is disposed in the storage space 15a of the housing 15. The storage space 15a includes an opening 15d on the side adjacent to the substrate B. The opening 15d of the housing 15 is covered with the electrolyte membrane 13. Specifically, the peripheral edge of the electrolyte membrane 13 is sandwiched between the housing 15 and a frame 17. Accordingly, the plating solution L in the storage space 15a can be sealed with the electrolyte membrane 13.

The housing 15 includes a supply port 15b for supplying the plating solution L to the storage space 15a. Further, the housing 15 includes a discharge port 15c for discharging the plating solution L from the storage space 15a. The supply port 15b and the discharge port 15c are holes communicating with the storage space 15a. The supply port 15b and the discharge port 15c are disposed with the storage space 15a interposed therebetween. The supply port 15b is connected to a liquid supply pipe 50. The discharge port 15c is fluidly connected to a liquid discharge pipe 52.

The film forming apparatus 1 further includes a liquid tank 90, a liquid supply pipe 50, a liquid discharge pipe 52, and a pump 80. As shown in FIG. 1, the liquid tank 90 stores the plating solution L. The liquid supply pipe 50 connects the liquid tank 90 and the housing 15. The liquid supply pipe 50 is provided with the pump 80. The pump 80 supplies the plating solution L from the liquid tank 90 to the housing 15. The liquid discharge pipe 52 connects the liquid tank 90 and the housing 15. The liquid discharge pipe 52 is provided with a pressure regulating valve 54. The pressure regulating valve 54 regulates the pressure (fluid pressure) of the plating solution L in the storage space 15a to a predetermined pressure.

In the present embodiment, by driving the pump 80, the plating solution L is sucked from the liquid tank 90 into the liquid supply pipe 50. The sucked plating solution L is pressure-fed from the supply port 15b to the storage space 15a. The plating solution L in the storage space 15a is returned to the liquid tank 90 via the discharge port 15c. In this way, the plating solution L circulates in the film forming apparatus 1.

By continuing the driving of the pump 80, the fluid pressure of the plating solution L in the storage space 15a can be maintained at a predetermined pressure by the pressure regulating valve 54. Instead of the pump 80, a piston and a cylinder for injecting the plating solution may be used to cause the fluid pressure of the plating solution L to act.

In one example, the mount base 40 is formed of a conductive material (e.g., metal). The mount base 40 includes a recess 41. The recess 41 is a recess for housing the substrate B.

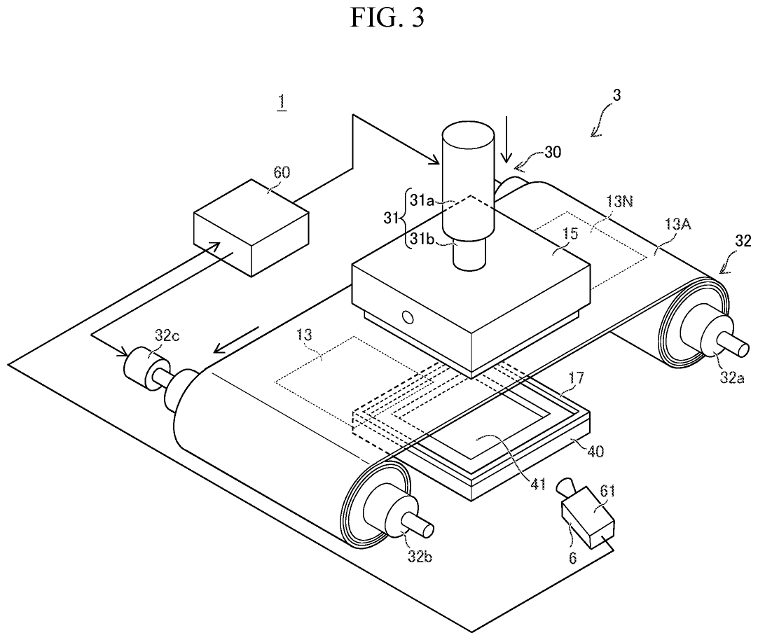

As shown in FIG. 3, in the present embodiment, the film forming apparatus 1 includes a replacement mechanism 3 configured to replace the electrolyte membrane 13 attached to the housing 15. The replacement mechanism 3 includes a conveying device 32 configured to convey the band body 13A made of electrolyte along the longitudinal direction and an attaching and detaching mechanism 30 configured to attach and detach the electrolyte membrane 13 to and from the housing 15.

As shown in FIG. 3, the conveying device 32 includes a roller 32a that feeds the band body 13A wound in a roll, a winding roller 32b that winds up the fed band body 13A, and a motor 32c that rotates the winding roller 32b. A control device 60 (described later) is electrically connected to the motor 32c to allow conveying the band body 13A while winding up the band body 13A by the winding roller 32b.

The attaching and detaching mechanism 30 is a mechanism configured to attach and detach the electrolyte membrane 13 to and from the housing 15, and includes a first linear actuator 31 and a second linear actuator 33 (see FIG. 2). The first linear actuator 31 and the second linear actuator 33 are electrically connected to the control device 60 and are driven according to a control signal from the control device 60.

As shown in FIG. 1 and FIG. 2, the first linear actuator 31 raises and lowers the housing 15 such that the electrolyte membrane 13 and the substrate B can be brought into contact with and separated from each other. The first linear actuator 31 includes a body 31a, and a rod 31b that linearly moves with respect to the body 31a. The housing 15 is being attached to the end of the rod 31b. In the present embodiment, the mount base 40 is fixed, and the housing 15 is moved up and down by the first linear actuator 31. The first linear actuator 31 is an electric actuator, and converts the rotational motion of the motor into a linear motion by a ball screw or the like (not shown). However, instead of an electric actuator, a hydraulic or pneumatic actuator may be used.

As shown in FIG. 3, the first linear actuator 31 serves to attach the electrolyte membrane 13 to the housing 15. Specifically, the rod 31b of the first linear actuator 31 is moved down such that the frame 17 detached from the housing 15 is fitted to the housing 15. This makes the band body 13A sandwiched between the housing 15 and the frame 17, thereby attaching the electrolyte membrane 13 to the housing 15.

As shown in FIG. 4, the second linear actuator 33 is being attached to the housing 15. A plurality of second linear actuators 33 are arranged with a gap therebetween on the peripheral edge of the opening 15d of the housing 15. The second linear actuator 33 includes a body 33a fixed to the housing 15 and a rod 33b that linearly moves with respect to the body 33a. As shown in FIG. 4, by driving the second linear actuator 33, the end of the rod 33b moves toward the frame 17, allowing the frame 17 to be detached from the housing 15. This allows the electrolyte membrane 13 (band body 13A) to be detached from the housing 15.

The film forming apparatus 1 includes a detecting device 6 that detects a state of the electrolyte membrane 13. In the present embodiment, the detecting device 6 is an imaging device 61 that captures an image of the electrolyte membrane 13. However, the detecting device 6 may be, for example, a laser displacement meter that detects a state of the surface of the electrolyte membrane 13 as long as the detecting device 6 can detect a state of the electrolyte membrane 13. The imaging device 61 captures a digital image of the electrolyte membrane 13 from the position below the electrolyte membrane 13 in a slanting direction.

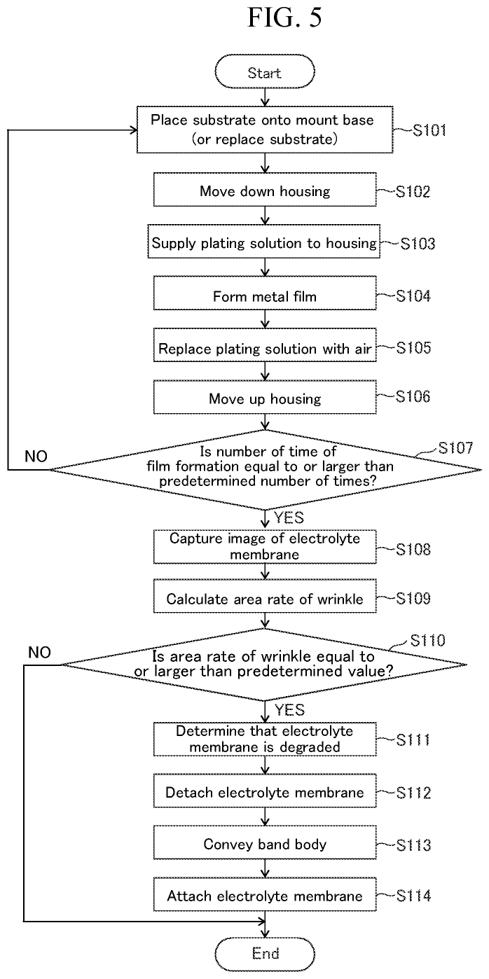

The film forming apparatus 1 includes the control device 60 that controls replacement of the electrolyte membrane 13. The control device 60 includes, as hardware, a storage device (not shown) that stores a program for the following control and an operation device (not shown) that executes the program. The control device 60 includes, as software, a program for execution of the following content. Specifically, the control of the control device 60 will be described referring to the control flow shown in FIG. 5.

First, in step S101, the control device 60 controls a conveying device (not shown) for conveying the substrate B to convey the substrate B onto the mount base 40. Note that when the metal film F has already been formed on the substrate B, the control device 60 replaces the substrate B. Next, in step S102, the control device 60 drives the first linear actuator 31 and moves down the housing 15 until the electrolyte membrane 13 attached to the housing 15 comes into contact with the substrate B.

Next, in step S103, the control device 60 drives the pump 80. Accordingly, the plating solution L is supplied to the storage space 15a of the housing 15. Since the liquid discharge pipe 52 is provided with the pressure regulating valve 54, the fluid pressure of the plating solution L in the storage space 15a can be maintained at a predetermined pressure. Consequently, as shown in FIG. 2, the substrate B can be pressed by the electrolyte membrane 13 with the fluid pressure of the plating solution L.

Next, in step S104, the control device 60 maintains the pressing state by the electrolyte membrane 13, and forms a metal film F. Specifically, the control device 60 applies a voltage between the anode 11 and the substrate B. As a result, metal ions contained in the electrolyte membrane 13 moves to the surface of the substrate B, and metal ions are reduced at the surface of the substrate B. Note that in manufacturing a wiring using the metal film F, a conductive underlayer formed on the surface of the insulating substrate B may be etched.

Next, in step S105, the control device 60 stops the driving of the pump 80 and replaces the plating solution L in the storage space 15a of the housing 15 with air (atmosphere). Herein, for example, the control device 60 may send compressed air to the storage space 15a by an air pump (not shown). Other than this, the control device 60 may open a valve (not shown) of a liquid discharge pipe (not shown) through which the storage space 15a is in communication with the atmosphere.

Next, in step S106, the control device 60 drives the first linear actuator 31, and moves up the housing 15 (see FIG. 1). Next, in step S107, the control device 60 counts the number of times of film formation on the plurality of substrates B after the last replacement of the electrolyte membrane 13, and determines whether the number of times of film formation is equal to or larger than a predetermined number of times. Herein, if the number of times of film formation is not equal to or larger than a predetermined number of times (NO), the control goes back to step S101, whereas if the number of times of film formation is equal to or larger than a predetermined number of times (YES), the control proceeds to step S108. In step S108 and the following steps, the control device 60 determines whether there is degradation in the electrolyte membrane 13 based on a result of detection by the detecting device (in the present embodiment, an image of the electrolyte membrane 13 captured by the imaging device 61).

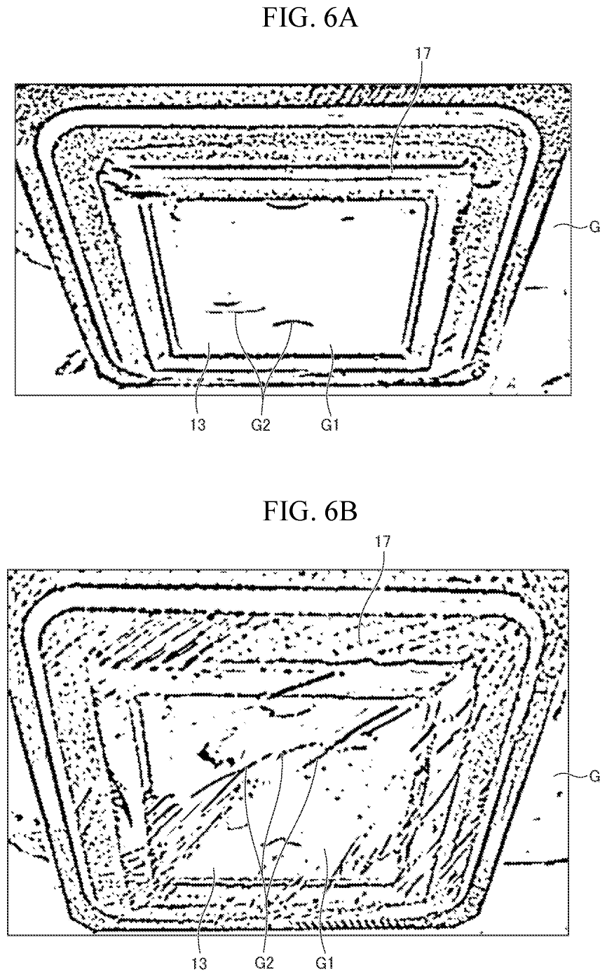

Specifically, in step S108, the control device 60 controls the imaging device 61 to capture an image of the electrolyte membrane 13. Accordingly, the control device 60 acquires an entire image G including the electrolyte membrane 13, for example (see FIG. 6A, FIG. 6B).

Next, the control proceeds to S109, where the control device 60 calculates an area rate of a wrinkle of the electrolyte membrane 13. First, the control device 60 performs binary processing on the entire image G including the electrolyte membrane 13. This allows more precise detection of the state of the electrolyte membrane 13, namely, from the state where the electrolyte membrane 13 includes substantially no wrinkle as shown in FIG. 5A to the state where the electrolyte membrane 13 includes the wrinkle as shown in FIG. 6B. Next, the control device 60 extracts an image G1 of the electrolyte membrane 13 from the entire image G shown in FIG. 6A, FIG. 6B. Among the number of pixels in the extracted image G1 of the electrolyte membrane 13, the control device 60 calculates the number of pixels in an image G2 of the wrinkle included in the image G1. Accordingly, the control device 60 can calculate an area rate of the wrinkle. Note that in the present embodiment, since the imaging device 61 can capture an image of the electrolyte membrane 13 in a specific direction from a specific position, the control device 60 can precisely measure an area rate of the wrinkle in the image G1 of the electrolyte membrane 13.

The control device 60 determines whether there is degradation in the electrolyte membrane 13 based on the area rate of the wrinkle. Specifically, in step S110, if the control device 60 determines that the area rate of the wrinkle is equal to or larger than a preset value (predetermined value) (YES), the control proceeds to step S111. If the area rate of the wrinkle is not equal to or larger than a preset value (predetermined value) (NO), a series of steps of the control ends. Otherwise, the control may go back to step S101. The “preset value” as used herein means an area rate of the wrinkle that may cause defective film formation of the metal film F, and can be obtained by an experiment or the like.

In step S111, the control device 60 determines that the electrolyte membrane 13 is degraded, and the control proceeds to step S112. In step S112 and the following steps, the control device 60 causes the replacement mechanism 3 to replace the electrolyte membrane 13. Specifically, in step S112, the control device 60 causes the attaching and detaching mechanism 30 to detach the electrolyte membrane 13 from the housing 15. More specifically, the control device 60 drives the second linear actuator 33 of the attaching and detaching mechanism 30 and presses down the frame 17 by the rod 33b of the second linear actuator 33. At this time, as shown in FIG. 4, the frame 17 is placed on the mount base 40 and the band body 13A including the electrolyte membrane 13 becomes movable from the housing 15.

Next, in step S113, the control device 60 causes the conveying device 32 to convey the band body 13A in the longitudinal direction to the position where an unused electrolyte membrane 13N faces the housing 15. Specifically, the control device 60 drives the motor 32c and conveys the band body 13A while winding up the band body 13A by the winding roller 32b.

Next, in step S114, the control device 60 drives the first linear actuator 31 of the attaching and detaching mechanism 30 and moves down the housing 15. This makes the band body 13A sandwiched between the housing 15 and the frame 17, thereby attaching the unused electrolyte membrane 13N to the housing 15.

In the present embodiment, as shown in FIG. 2, a metal film F is formed on the surface of the substrate B in a state where the electrolyte membrane 13 is pressed against the surface of the substrate B with the fluid pressure of the plating solution L. Repeated formation of the metal film F causes the electrolyte membrane 13 to not only contact the plating solution L for a long period of time, but also be subjected to the fluid pressure of the plating solution L. This produces a wrinkle of the electrolyte membrane 13 and causes further degradation in the electrolyte membrane 13 as the wrinkle increases.

Thus, in the present embodiment, using the image G1 of the electrolyte membrane 13 captured by the imaging device 61 as the detection result, the control device 60 calculates an area rate of the wrinkle formed in the electrolyte membrane 13 from the image G1 of the electrolyte membrane 13. Since this area rate of the wrinkle depends on the degree of degradation in the electrolyte membrane 13, the control device 60 can determine, based on the area rate of the wrinkle, whether there is degradation in the electrolyte membrane 13, which serves as a reference for replacing the electrolyte membrane 13.

If the control device 60 determines that the electrolyte membrane 13 is degraded, the control device 60 controls the replacement mechanism 3, thereby replacing the degraded electrolyte membrane 13 with an unused electrolyte membrane 13N. Consequently, it is possible to replace the electrolyte membrane 13 at a proper timing along with further degradation in the electrolyte membrane 13.

In particular, in the present embodiment, under the control of the control device 60, the second linear actuator 33 of the attaching and detaching mechanism 30 detaches the electrolyte membrane 13 from the housing 15, and the conveying device 32 conveys the band body 13A to the position where the unused electrolyte membrane 13N faces the housing 15. In this way, when replacing the electrolyte membrane 13, a plurality of times of replacement of the electrolyte membrane 13 are available from one band body 13A.

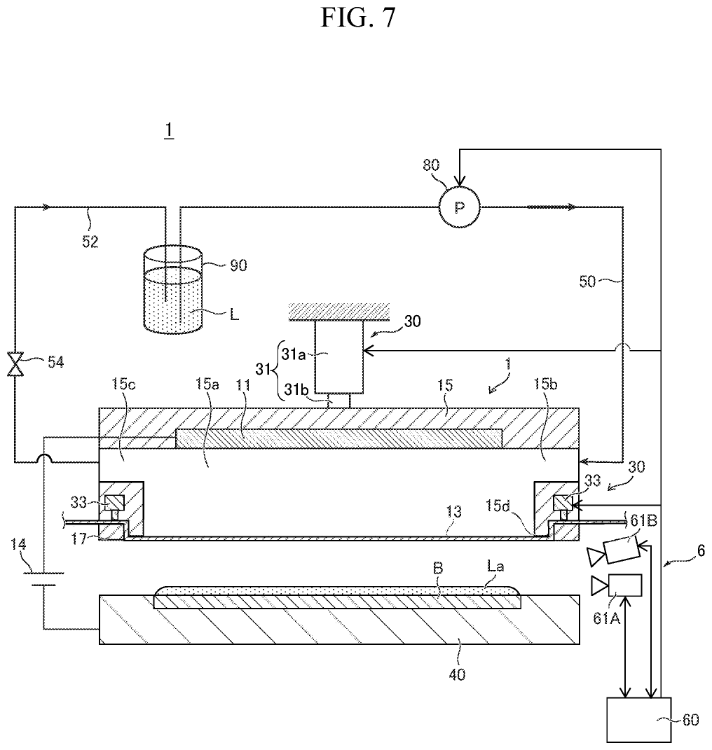

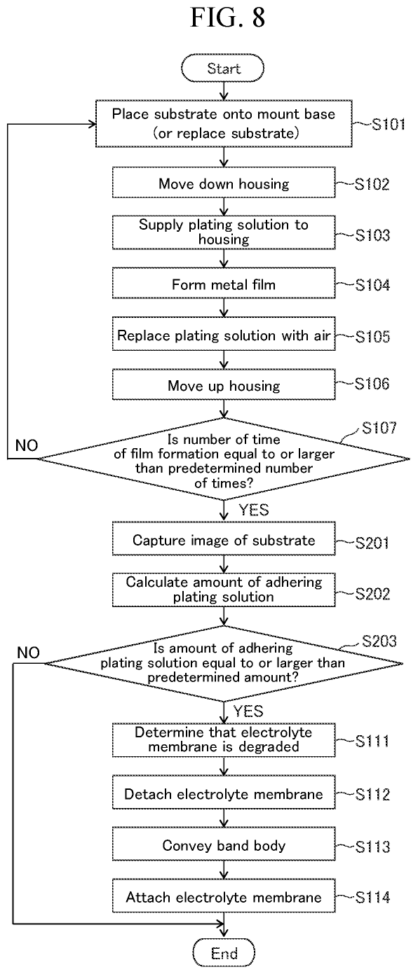

FIG. 7 is a schematic cross-sectional view of an example of the film forming apparatus 1 for forming a metal film according to a modification. FIG. 8 is a flowchart of the film forming method and replacement of an electrolyte membrane using the film forming apparatus shown in FIG. 7. Hereinafter, only the difference from the above-described embodiment will be described in detail.

During film formation, the electrolyte membrane 13 comes into contact with the substrate in a state where the electrolyte membrane 13 is stretched with the fluid pressure of the plating solution L. Repetition of such a phenomenon causes the plating solution L to easily pass through the electrolyte membrane 13. As a result, the plating solution La in an amount larger than expected tends to adhere to the surface of the substrate B after film formation, as shown in FIG. 7. Such a state of the electrolyte membrane 13 is a state where there is degradation in the electrolyte membrane.

In view of this, in this modification, the detecting device 6 detects the state of the surface of the substrate B. Specifically, the detecting device 6 includes first and second imaging devices 61A, 61B. The first and second imaging devices 61A, 61B capture images of the surface of the substrate B and the plating solution La adhering to this surface from different angles. Specifically, the first imaging device 61A is disposed so as to capture an image of the surface of the substrate B from the horizontal position. The second imaging device 61B is disposed so as to capture an image of the surface of the substrate B from the position above the surface of the substrate B in a slanting direction.

As shown in FIG. 8, the control from step S101 to step S107 and from step S111 to step S114 is equal to that described referring to FIG. 5, and the control from step S201 to step S203 is different. From step S201 to step S203, the control device 60 determines whether there is degradation in the electrolyte membrane 13 based on a result of detection by the detecting device (in the present embodiment, images of the surface of the substrate B captured by the first and second imaging devices 61A, 61B).

Specifically, in step S201, the control device 60 causes the first and second imaging devices 61A, 61B to capture images of the surface of the substrate B. These images include an image of the substrate B and an image of the plating solution La adhering to the substrate B.

Then, in step S202, the control device 60 estimates an amount of the plating solution La adhering to the surface of the substrate B from the images of the surface of the substrate B captured by the first and second imaging devices 61A, 61B. Specifically, the control device 60, for example, detects the thickness of the plating solution La adhering to the surface of the substrate B from the image captured by the first imaging device 61A and detects the area of the plating solution La adhering to the surface of the substrate B from the image captured by the second imaging device 61B. By multiplying the thickness of the plating solution La by the area of the plating solution La, the control device 60 estimates the amount (volume) of the plating solution La adhering to the surface of the substrate B. However, when the control device 60 can estimate the amount of the adhering plating solution La from either one of the thickness of the plating solution La or the area of the plating solution La, the control device 60 may use either the first imaging device 61A or the second imaging device 61B.

The control device 60 determines whether there is degradation in the electrolyte membrane 13 based on the amount of the plating solution La adhering to the surface of the substrate B. Specifically, in step S203, if the control device 60 determines that the amount of the adhering plating solution La is equal to or larger than a preset amount (predetermined value) (YES), the control proceeds to step S111, where the control device 60 determines that the electrolyte membrane 13 is degraded. If the amount of the adhering plating solution La is not equal to or larger than a preset amount (predetermined value) (NO), a series of steps of the control ends. Otherwise, the control may go back to step S101. The “preset amount” as used herein means the amount of the adhering plating solution La that may cause defective film formation of the metal film F, and can be obtained by an experiment or the like.

In this modification, since the amount of the adhering plating solution La depends on the degree of degradation in the electrolyte membrane 13, the control device 60 can determine whether there is degradation in the electrolyte membrane 13 and replace the electrolyte membrane 13 at a proper timing.

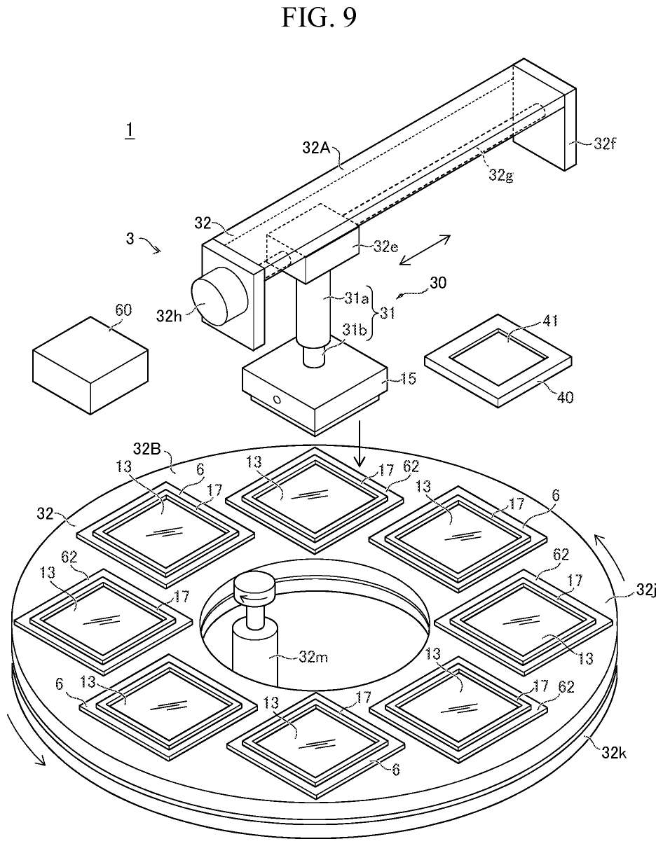

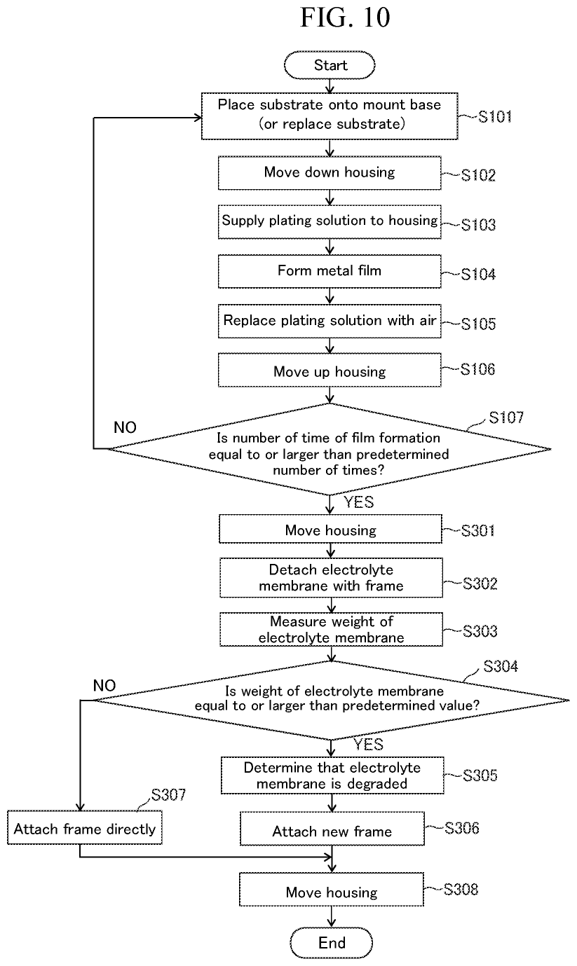

FIG. 9 is a schematic cross-sectional view of an example of a film forming apparatus for forming a metal film according to another modification, and FIG. 10 is a flowchart of the film forming method and replacement of an electrolyte membrane using the film forming apparatus shown in FIG. 9. Hereinafter, only the difference from the above-described embodiment will be described in detail.

During film formation, the electrolyte membrane 13 comes into contact with the substrate in a state where the electrolyte membrane 13 is stretched with the fluid pressure of the plating solution L. Repetition of such a phenomenon causes the electrolyte membrane 13 to be impregnated with the plating solution L and swell, and increases the weight of the electrolyte membrane 13. As a result, the film strength of the electrolyte membrane 13 may be decreased. Such a state of the electrolyte membrane 13 is a state where there is degradation in the electrolyte membrane.

In the present embodiment, the electrolyte membrane 13 is removably attached to the housing 15 via the frame 17. The electrolyte membrane 13 is securely attached to the frame 17. The replacement mechanism 3 includes the conveying device 32 that conveys the frame 17. Note that the attaching and detaching mechanism 30 that attaches and detaches the frame 17 to and from the housing 15 is equal to that of the above-described embodiment.

The conveying device 32 includes a linear guide 32A and a rotary table 32B. A first motor 32h is attached to the linear guide 32A. A rotating shaft 32g is attached to the output shaft of the first motor 32h, and a support 32e is threadedly attached to the rotating shaft 32g. Driving the first motor 32h allows moving the housing 15 together with the support 32e from the mount base 40 to the rotary table 32B.

The rotary table 32B includes a fixed base 32k, a rotating base 32j, and a second motor 32m. The second motor 32m abuts on the inner peripheral surface of the ring-shaped rotating base 32j. Driving the second motor 32m allows rotating the rotating base 32j together with the frame 17. The first motor 32h and the second motor 32m are electrically connected to the control device 60 (not shown).

In the rotating base 32j, the frames 17 each having the electrolyte membrane 13 securely attached thereto are spaced equidistantly in the rotating direction. The rotating base 32j is provided with the detecting device 6 that detects the state of the electrolyte membrane 13. The detecting device 6 is a weight measuring device 62 that measures the weight of the electrolyte membrane 13 together with the frame 17. The result of measurement by the weight measuring device 62 is transmitted to the control device 60.

As shown in FIG. 10, the control from step S101 to step S107 is equal to that described referring to FIG. 5, and the control from step S301 to step S308 is different. In step S301, the control device 60 drives the first motor 32h of the linear guide 32A, and moves the housing 15 to the position above the rotary table 32B.

Next, in step S302, the control device 60 causes the attaching and detaching mechanism 30 to detach the frame 17 from the housing 15 together with the electrolyte membrane 13. Specifically, as described above, the control device 60 drives the second linear actuator 33 of the attaching and detaching mechanism 30 and presses down the frame 17 by the rod 33b of the second linear actuator 33. At this time, as shown in FIG. 9, the frame 17 is placed on the rotary table 32B together with the electrolyte membrane 13.

In step S303, the control device 60 causes the weight measuring device 62 to measure the weight of the electrolyte membrane 13. Herein, a value obtained by subtracting in advance the weight of the frame 17 from the measurement value obtained by the weight measuring device 62 is defined as the weight of the electrolyte membrane 13.

In step S304, the control device 60 determines whether there is degradation in the electrolyte membrane 13 based on the weight of the electrolyte membrane 13 measured by the weight measuring device 62. Specifically, in step S304, if the control device 60 determines that the weight of the electrolyte membrane 13 is equal to or larger than a preset value (predetermined value) (YES), the control proceeds to step 305, where the control device 60 determines that there is degradation in the electrolyte membrane 13. If the weight of the electrolyte membrane 13 is not equal to or larger than a preset value (predetermined value) (NO), the control proceeds to step S307. The “preset value” as used herein means the weight of the electrolyte membrane 13 that may cause defective film formation of the metal film F, and can be obtained by an experiment or the like.

In step S306, the control device 60 first conveys the detached frame 17 to the rotary table 32B to a position spaced from the housing 15, and then conveys the frame 17 having an unused electrolyte membrane 13 securely attached thereto to a position facing the housing 15. Specifically, the control device 60 drives the second motor 32m and moves the rotating base 32j to a position where a next new frame 17 (electrolyte membrane 13) faces the housing 15. The control device 60 drives the first linear actuator 31 of the attaching and detaching mechanism 30 and moves down the housing 15. Accordingly, the frame 17 is attached to the housing 15 together with the electrolyte membrane 13.

In contrast, in step S307, the control device 60 determines that the electrolyte membrane 13 is not degraded, and without driving the second motor 32m, drives the first linear actuator 31 of the attaching and detaching mechanism 30 to attach the detached frame 17 directly to the housing 15.

In step S308, the control device 60 drives the first motor 32h of the linear guide 32A and moves the housing 15 from the rotary table 32B to the mount base 40.

In this modification, since the weight of the electrolyte membrane 13 depends on the degree of degradation in the electrolyte membrane 13, the control device 60 can determine whether there is degradation in the electrolyte membrane 13 and replace the electrolyte membrane 13 at a proper timing. Further, under the control of the control device 60, the attaching and detaching mechanism 30 can detach the degraded electrolyte membrane 13 from the housing 15 together with the frame and attach to the housing 15 the unused electrolyte membrane 13 securely attached to the different frame 17. In this way, the electrolyte membrane 13 can be simply replaced together with the frame 17.

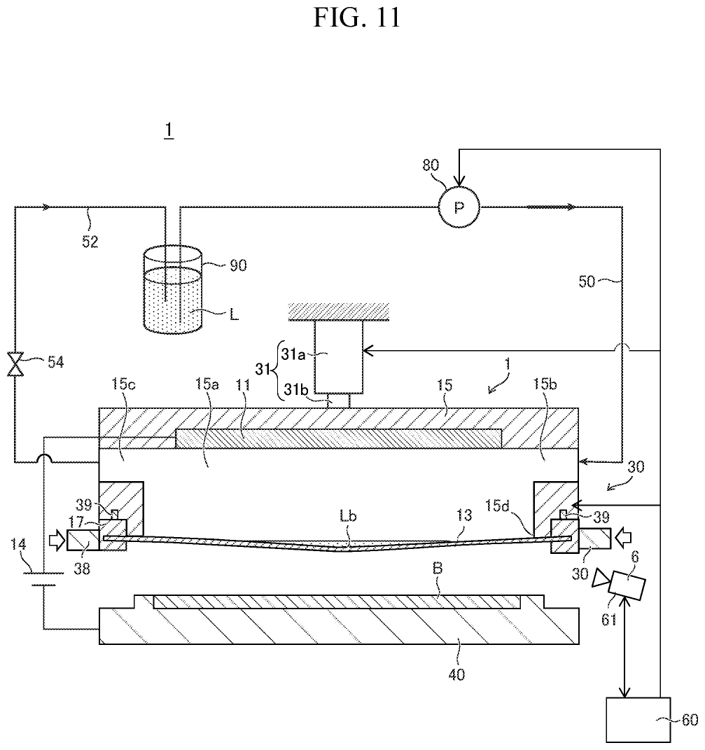

FIG. 11 is a schematic cross-sectional view of an example of a film forming apparatus for forming a metal film according to yet another modification. The film forming apparatus 1 includes a detecting device 6 that detects a state of the electrolyte membrane 13. In the present embodiment, the detecting device 6 is an imaging device 61 that captures an image of the electrolyte membrane 13. In this modification, the control from step S101 to step S108 is equal to that shown in FIG. 5.

Here, when replacing the plating solution L with air in step S105 shown in FIG. 5, the electrolyte membrane 13 may be sagged by the fluid pressure of the plating solution Lb, and such sagging causes the plating solution Lb to accumulate on the electrolyte membrane 13 as shown in FIG. 11. When such an electrolyte membrane 13 is captured by the imaging device 61, the image of the portion of the electrolyte membrane 13 on which the plating solution Lb is accumulating has a different color from the other portion of the electrolyte membrane 13. Thus, in this modification, the control device 60 calculates an area rate of the portion of the electrolyte membrane 13 on which the plating solution Lb is accumulating, and estimates an amount of sagging of the electrolyte membrane 13 from the calculated area rate. It should be noted that instead of the imaging device 61, a laser displacement meter may be used for detecting an amount of sagging of the electrolyte membrane 13.

The control device 60 determines whether there is degradation in the electrolyte membrane 13 based on the amount of sagging of the electrolyte membrane 13. Specifically, if the control device 60 determines that the amount of sagging of the electrolyte membrane 13 is equal to or larger than a preset value (predetermined value) (YES), the control proceeds to the step of replacing the electrolyte membrane 13. If the amount of sagging of the electrolyte membrane 13 is not equal to or larger than a preset value (predetermined value) (NO), a series of steps of the control ends. The “preset value” as used herein means an amount of sagging of the electrolyte membrane 13 that may cause defective film formation of the metal film F, and can be obtained by an experiment or the like.

Furthermore, the film forming apparatus 1 includes a robot hand 38. The robot hand 38 has a function of the attaching and detaching mechanism 30 and the conveying device 32. In the step of replacing the electrolyte membrane 13, the control device 60 causes the robot hand 38 to detach the frame 17 from the housing 15 and convey the frame 17, and thereafter attach to the housing 15 the frame 17 having a new electrolyte membrane 13 securely attached thereto.

Although the embodiment of the present disclosure has been described in detail above, the present disclosure is not limited to the above embodiment, and various design changes are possible in so far as they are within the spirit of the present disclosure in the scope of the claims.

In the present embodiment and the modifications, some detecting devices and some replacement mechanisms have been shown as examples. However, the present disclosure is not limited to the combination of the detecting device and the replacement mechanism of the present embodiment and the modifications, and the detecting devices and replacement mechanisms may be replaced with other detecting devices or other replacement mechanisms.

What is claimed is:

1. A film forming apparatus for forming a metal film on a surface of a substrate by electroplating in a state where an electrolyte membrane is pressed against the surface of the substrate with a fluid pressure of a plating solution, the film forming apparatus comprising:
a housing for containing a plating solution, the housing having the electrolyte membrane removably attached thereto;
a replacement mechanism configured to replace the electrolyte membrane attached to the housing;
a detecting device configured to detect a state of the electrolyte membrane or a state of the surface of the substrate after film formation; and
a control device configured to control replacement of the electrolyte membrane,
wherein the control device determines whether there is degradation in the electrolyte membrane based on a result of detection by the detecting device, and if it is determined the electrolyte membrane is degraded, causes the replacement mechanism to replace the electrolyte membrane.

2. The film forming apparatus for forming a metal film according to claim 1,
wherein the detecting device is an imaging device configured to capture an image of the electrolyte membrane, and
wherein the control device estimates an area rate of a wrinkle formed in the electrolyte membrane or an amount of sagging of the electrolyte membrane from an image of the electrolyte membrane captured by the imaging device, and determines whether there is degradation in the electrolyte membrane based on the area rate of the wrinkle or the amount of sagging of the electrolyte membrane.

3. The film forming apparatus for forming a metal film according to claim 1,
wherein the detecting device is an imaging device configured to capture an image of the surface of the substrate after film formation, and
wherein the control device estimates an amount of the plating solution adhering to the surface of the substrate from an image of the surface of the substrate captured by the imaging device and determines whether there is degradation in the electrolyte membrane based on the amount of the plating solution adhering to the surface of the substrate.

4. The film forming apparatus for forming a metal film according to claim 1,
wherein the detecting device is a weight measuring device configured to measure a weight of the electrolyte membrane, and
wherein the control device determines whether there is degradation in the electrolyte membrane based on the weight measured by the weight measuring device.

5. The film forming apparatus for forming a metal film according to claim 1,
wherein the electrolyte membrane to be attached to the housing is a portion of a band body made of electrolyte,
wherein the replacement mechanism comprises: a conveying device configured to convey the band body in a longitudinal direction; and an attaching and detaching mechanism configured to attach and detach the electrolyte membrane to and from the housing, and
wherein when replacing the electrolyte membrane, the control device causes the attaching and detaching mechanism to detach the electrolyte membrane from the housing, causes the conveying device to convey the band body to a position where an unused electrolyte membrane faces the housing, and causes the attaching and detaching mechanism to attach the unused electrolyte membrane to the housing.

6. The film forming apparatus for forming a metal film according to claim 1,
wherein the electrolyte membrane is removably attached to the housing via a frame,
wherein the electrolyte membrane is securely attached to the frame,
wherein the replacement mechanism comprises: a conveying device configured to convey the frame; and an attaching and detaching mechanism configured to attach and detach the frame to and from the housing, and
wherein when replacing the electrolyte membrane, the control device causes the attaching and detaching mechanism to detach the frame from the housing, causes the conveying device to convey the detached frame to a position spaced from the housing and thereafter convey a frame having an unused electrolyte membrane securely attached thereto to a position facing the housing, and causes the attaching and detaching mechanism to attach the frame having an unused electrolyte membrane securely attached thereto to the housing.
